(19) United States
(12) Patent Application Publication
(10) Pub. No.: US 2018/0089045 A1
(43) Pub. Date: Mar. 29, 2018

(54) METHOD AND DEVICE FOR PERFORMING HARDWARE MODULE DIAGNOSTICS

(71) Applicant: Lenovo (Singapore) Pte. Ltd., New Tech Park (SG)

(72) Inventors: Arnold S. Weksler, Raleigh, NC (US); Rafael Rodrigues Machado, Sorocaba (BR)

(21) Appl. No.: 15/277,352

(22) Filed: Sep. 27, 2016

(51) Int. Cl. G06F 11/263; G06F 11/22

(52) U.S. Cl. CPC G06F 11/263; G06F 11/2268

(57) ABSTRACT

A computer implemented method, device and computer program device are provided that is under control of one or more processors that are configured with specific executable program instructions. The method identifies a candidate hardware (HW) module to be tested for a potential failure. The candidate HW module is connected through an intermediate HW module with a test management module. The test management module manages diagnostic testing for the potential failure. The method obtains first and second diagnostic tests. The first diagnostic test is associated with the intermediate HW module and the second diagnostic test is associated with the candidate HW module. The method applies the first diagnostic test to the intermediate HW module to verify operation of the intermediate HW module and applies the second diagnostic test to the candidate HW module based on verified operation of the intermediate HW module.

### FIELD

The present disclosure relates generally to the performance of diagnostics testing, and more particularly to methods and devices that perform diagnostics based on a hardware module hierarchy.

### BACKGROUND OF THE INVENTION

Today, electronic devices are being developed that involve more and more complex circuitry. Virtually all electronic devices are constructed with various combinations of hardware and software modules. For example, a hardware module may include a circuit board with various electrical components such as chipsets, memory components, PCI cards, video cards, USB ports, hard disk drives and the like. Each hardware module is coupled to other hardware modules through a variety of intermediate and peripheral hardware modules.

Over time various software and hardware modules experience different types of failures. A variety of diagnostic applications are offered to identify and/or troubleshoot failures. In general, individual diagnostic tests are provided in connection with particular types of hardware (HW) and software (SW) modules. Accordingly, when an individual hardware module is tested, the corresponding diagnostic test is utilized. For example, it is common to have individual diagnostic applications that are tailored to check hard disk drives, and the like.

However, existing approaches to hardware diagnostic testing experience certain limitations. In general, diagnostic applications are managed from a central processing unit (CPU). As part of a corresponding diagnostic test, the CPU may send individual diagnostic instructions to the hardware module being tested. The CPU then waits for a corresponding diagnostic result to be returned from the hardware module being tested. Often, diagnostic instructions and results are conveyed through one or more intermediate HW modules when passing between the CPU and the hardware module being tested.

The diagnostic instructions are conveyed along a communications link in a “downstream” direction from the CPU, through the intermediate hardware modules to the hardware module being tested. The diagnostic results are conveyed along a communications link in an “upstream” direction from the hardware module being tested, through the intermediate hardware modules to the CPU. The number of intermediate HW modules and nature of the intermediate HW modules will vary depending upon the overall construction of the device and the particular hardware module being tested.

In some instances, one or more of the intermediate HW modules may be experiencing some form of failure. A failure within an intermediate HW module may be interpreted by the CPU as a failure in a downstream hardware module being tested, even though the failure may occur at the intermediate HW module along the communications link. Accordingly, when a CPU sends a diagnostic instruction and does not receive a valid corresponding diagnostic result, the CPU may determine that the module designated for testing is experiencing the failure. However, in reality, the module designated for testing may not be the module experiencing the failure (or may not be the only module experiencing a failure). Instead, an intermediate HW module may be experiencing the failure that appears, to the CPU, as a failure at the module designated for testing.

As a particular example, the CPU may determine that a USB device appears to be experiencing a failure. Accordingly, the CPU may identify a diagnostic test for the USB device and, in connection there with, send diagnostic instructions intended to be performed by the USB device. The CPU waits for the corresponding diagnostic results. However, the CPU may receive no diagnostic results and/or receive diagnostic results that are incorrect. Heretofore, the CPU would declare the USB device to be experiencing a fault and take the appropriate corrective action and/or provide the appropriate notification to the user. Hence the CPU would potentially be declaring the USB device to be faulty, when the actual source of the fault is on an intermediate HW module.

A need remains for improved methods and devices that provide device hierarchy based hardware diagnostic tests that overcome the foregoing problems and other disadvantages that will become apparent herein.

### SUMMARY

In accordance with embodiments herein, a computer implemented method is provided. The method is under control of one or more processors that are configured with specific executable program instructions. The method identifies a candidate hardware (HW) module to be tested for a potential failure. The candidate HW module is connected through an intermediate HW module with a test management module. The test management module manages diagnostic testing for the potential failure. The method obtains first and second diagnostic tests. The first diagnostic test is associated with the intermediate HW module and the second diagnostic test is associated with the candidate HW module. The method applies the first diagnostic test to the intermediate HW module to verify operation of the intermediate HW module and applies the second diagnostic test to the candidate HW module based on verified operation of the intermediate HW module.

Optionally, the method may further obtain a module hierarchy designating the intermediate HW module based on a communications link through the intermediate HW module between the test management module and candidate HW module. The method may identify the first diagnostic test associated with the intermediate HW module. The method may declare the intermediate HW module to exhibit a failure when the first diagnostic test indicates a fault. The method may suspend application of the second diagnostic test when the intermediate HW module is declared to exhibit a fault.

Optionally, the intermediate HW module may include upstream and downstream intermediate HW modules arranged along a communications link between the test management module and the candidate HW module. The method may apply corresponding diagnostic tests to the upstream and downstream intermediate HW modules to verify operation thereof and may apply the second diagnostic test to the candidate HW module based on verified operation of the upstream and downstream intermediate HW modules. The method may determine whether a module hierarchy is known in connection with the candidate HW module, and may obtain a module hierarchy based on the determining. Applying the first diagnostic test may include conveying diagnostic actions to be performed by the intermediate HW module and receiving test results corresponding to the diagnostic actions. The method may further comprise receiving test results from the intermediate HW module based on the first diagnostic test. The method may compare the test results with valid results and verifying the intermediate HW module based on the comparison.

In accordance with embodiments herein, a device is provided. The device comprises a processor and a memory storing program instructions accessible by the processor. Responsive to execution of the program instructions, the processor identifies a candidate hardware (HW) module to be tested for a potential failure. The candidate HW module is connected through an intermediate HW module with a test management module. The test management module manages diagnostic testing for the potential failure. The processor obtains first and second diagnostic tests. The first diagnostic test is associated with the intermediate HW module and the second diagnostic test is associated with the candidate HW module. The processor applies the first diagnostic test to the intermediate HW module to verify operation of the intermediate HW module and applies the second diagnostic test to the candidate HW module based on verified operation of the intermediate HW module.

Optionally, the processor may obtain a module hierarchy designating the intermediate HW module based on a communications link through the intermediate HW module between the test management module and candidate HW module. The processor may identify the first diagnostic test associated with the intermediate HW module. The processor may declare the intermediate HW module to exhibit a failure when the first diagnostic test indicates a fault. The processor may suspend application of the second diagnostic test when the intermediate HW module is declared to exhibit a fault. The intermediate HW module may include upstream and downstream intermediate HW modules arranged along a communications link between the test management module and the candidate HW module. The processor may apply corresponding diagnostic tests to the upstream and downstream intermediate HW modules to verify operation thereof and may apply the second diagnostic test to the candidate HW module based on verified operation of the upstream and downstream intermediate HW modules.

Optionally, the processor may obtain determines whether a module hierarchy is known in connection with the candidate HW module and may obtain a module hierarchy based on the determination. The processor may apply the first diagnostic test by conveying diagnostic actions to be performed by the intermediate HW module and receiving test results corresponding to the diagnostic actions. The processor may receive test results from the intermediate HW module based on the first diagnostic test, compare the test results with valid results and may verify the intermediate HW module based on the comparison.

In accordance with embodiments herein, a computer program product is provided. The computer program product comprises a non-signal computer readable storage medium comprising computer executable code to identify a candidate hardware (HW) module to be tested for a potential failure. The candidate HW module is connected through an intermediate HW module with a test management module. The test management module manages diagnostic testing for the potential failure. The program obtains first and second diagnostic tests. The first diagnostic test is associated with the intermediate HW module and the second diagnostic test is associated with the candidate HW module. The program applies the first diagnostic test to the intermediate HW module to verify operation of the intermediate HW module and applies the second diagnostic test to the candidate HW module based on verified operation of the intermediate HW module.

Optionally, the computer executable code may further comprise obtaining a module hierarchy designating the intermediate HW module based on a communications link through the intermediate HW module between the test management module and candidate HW module, and identifying the first diagnostic test associated with the intermediate HW module. The computer executable code may further comprise declaring the intermediate HW module to exhibit a failure when the first diagnostic test indicates a fault. The computer executable code may further comprising suspending application of the second diagnostic test when the intermediate HW module is declared to exhibit a fault.

### BRIEF DESCRIPTION OF THE DRAWINGS

FIG. 1 illustrates a simplified block diagram of an electronic device for which hierarchy-based diagnostic testing may be performed in accordance with embodiments herein.

FIG. 2A is a block diagram illustrating an example of a module hierarchy that may be determined and stored in accordance with an embodiment herein.

FIG. 2B illustrates a block diagram of a diagnostic test hierarchy that may be utilized to interrelate diagnostic tests in accordance with embodiments herein.

FIG. 3 illustrates a process for implementing a hierarchy-based module diagnostic in accordance with an embodiment herein.

FIG. 4 illustrates collections of diagnostic tests that may be utilized in connection with embodiments herein.

FIG. 5 is a block diagram of a system for hierarchy based hardware module diagnostics in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term hardware or HW module, as used throughout, is used to refer to a physical electronic circuit or device that may include one or more electronic components that operate together in connection with providing one or more features or functions of a larger electronic device. As nonlimiting examples, a hardware module may represent a motherboard with the various processors, memories and other electronic components thereon. A hardware module may represent a simple electronic component, such as a USB port, or a complex combination of electronic components, such as a video card. Various examples of hardware modules are discussed herein.

In accordance with embodiments herein, methods and devices are provided that afford device hierarchy based hardware diagnostic testing. A hierarchy is determined for the hardware modules within the device. The hierarchy describes the organization of different hardware modules that are interconnected with one another through one or more power, control or data links (collectively communications links). In connection with each hardware module, one or more diagnostic tests are identified that may be performed to verify whether the corresponding hardware module operates properly or exhibits some form of failure. In accordance with embodiments herein, diagnostic tests are defined in connection with validating individual hardware modules. The diagnostic tests include one or more diagnostic test to be applied to the candidate HW module (the module designated to be analyzed). The diagnostic tests also include one or more diagnostic tests associated with intermediate HW modules that are physically and electrically connected between the candidate HW module and a test management or base module (e.g. the CPU or motherboard) that is configured to manage the diagnostic test. The base module may also be referred to as a test management module, which may represent a motherboard or main CPU, or alternatively a daughter board or secondary CPU.

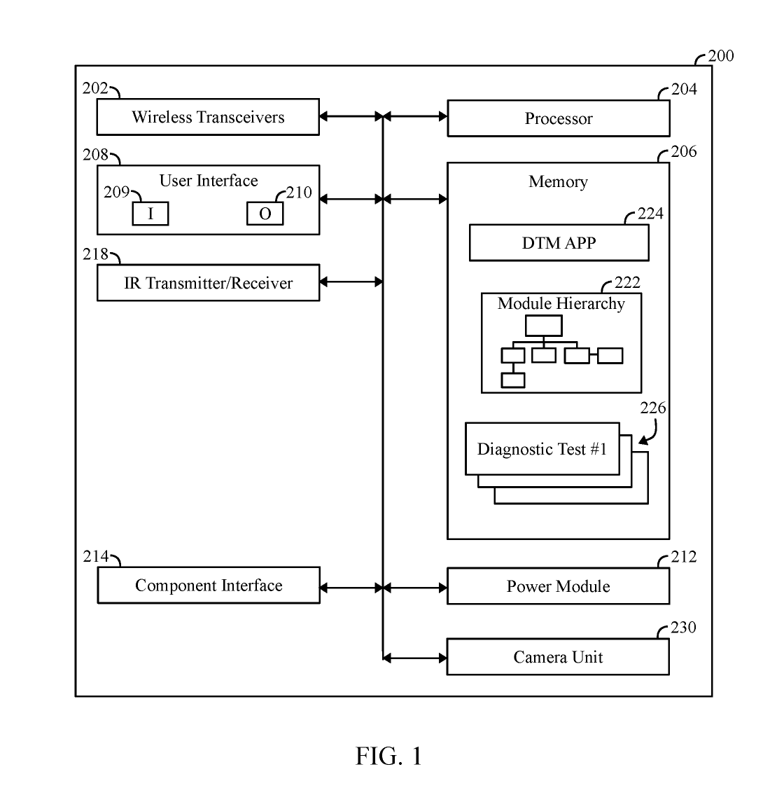

FIG. 1 illustrates a simplified block diagram of an electronic device 200 for which hierarchy-based diagnostic testing may be performed in accordance with embodiments herein. The device 200 includes components such as one or more wireless transceivers 202, one or more processors 204 (e.g., a microprocessor, microcomputer, application-specific integrated circuit, etc.), one or more memory (also referred to as a memory portion) 206, a user interface 208 which includes one or more input devices 209 and one or more output devices 210, a power module 212, a component interface 214 and a camera unit 230. All of the foregoing components can be operatively coupled to one another, and can be in communication with one another, by way of one or more internal communication links, such as an internal bus. The camera unit 230 may capture one or more frames of image data.

The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof. Optionally, an infrared transmitter and receiver 218 may be provided.

Each transceiver 202 can utilize a known wireless technology for communication. Exemplary operation of the wireless transceivers 202 in conjunction with other components of the device 200 may take a variety of forms and may include, for example, operation in which, upon reception of wireless signals, the components of device 200 detect communication signals from secondary devices and the transceiver 202 demodulates the communication signals to recover incoming information, such as responses to inquiry requests, voice and/or data, transmitted by the wireless signals. The processor 204 formats outgoing information and conveys the outgoing information to one or more of the wireless transceivers 202.

The memory 206 can encompass one or more memory devices of a variety of forms (e.g., read only memory, random access memory, static random access memory, dynamic random access memory, etc.). The data that is stored by the memory 206 can include, but need not be limited to, operating systems, applications, user collected content and informational data. Each operating system includes executable code that controls basic functions of the device, such as interaction among the various components, communication with external devices via the wireless transceivers 202 and/or the component interface 214, and storage and retrieval of applications and data to and from the memory 206. Each application includes executable code that utilizes an operating system to provide more specific functionality for the communication devices, such as file system service and handling of protected and unprotected data stored in the memory 206.

A device based hierarchy diagnostic test management (DTM) application 224 is stored in memory 206. The DTM application 224 includes program instructions accessible by the one or more processors 204 to direct the processor 204 to implement the methods, processes and operations described herein including, but not limited to the methods, processes and operations illustrated in the FIGS. and described in connection with the FIGS.

The DTM application 224 manages operation of the processor 204 in connection with identifying a candidate HW module to be tested for a potential failure. The DTM application 224 obtains at least first and second diagnostic tests, where the first diagnostic test is associated with the intermediate HW module and the second diagnostic test is associated with the test. The DTM application 224 applies the first diagnostic test to the intermediate HW module to verify operation of the intermediate HW module; and thereafter applying the second diagnostic test to the candidate HW module when operation of the intermediate HW module is verified with the first diagnostic test. Example embodiments are described hereafter for obtaining and applying the various diagnostic tests.

Other applications stored in the memory 206 include various application program interfaces (APIs), some of which provide links to/from the cloud hosting service. The power module 212 preferably includes a power supply, such as a battery, for providing power to the other components while enabling the device 200 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

The memory 206 also stores a HW module hierarchy 222 that defines a network of physical and electrical interconnection links between various hardware modules within the device. The electrical interconnection links may correspond to power supply interconnections, data buses, control lines and/or other data links over which control signals, commands, data, power and other information are conveyed in one direction or both directions (collectively referred to herein as communication links). The module hierarchy 222 may describe physical and/or electrical parameters and capabilities of each hardware module. For example, the module hierarchy 222 may define, in connection with a memory hard drive, one or more parameters and capabilities regarding the drive configuration, performance specifications, power requirements, power mode definitions, interface descriptions, host software interface description and the like. As one example, the module hierarchy 222 may include the type of parameters and/or capabilities described in the technical specification at: http://www.seagate.com/staticfiles/maxtor/en_us/documentation/manuals/fireball_531dx _manual.pdf , the complete subject matter of which is expressly Incorporated herein by reference in its entirety. As another example, the module hierarchy 222 may define, in connection with a video card, one or more parameters and/or capabilities regarding the core processor, the memory configuration, the memory interface, and the like.

The memory 206 also stores multiple diagnostic tests 226. Each diagnostic test 226 is associated with a corresponding hardware module. One or more diagnostic tests 226 may be associated with a single hardware module. More than one hardware module may utilize the same diagnostic test 226. As explained herein, various combinations of the diagnostic tests 226 are utilized when performing a hardware module diagnostic. The diagnostic tests 226 and module hierarchy 222 may be organized in various manners and stored in a common memory 206 and/or distributed between multiple different memories. For example, the diagnostic tests 226 and module hierarchy 222 may be stored in a distributed manner, such that a portion is stored on the device 200, while other portions are stored within memory on a remote server. For example, certain types of diagnostic tests 226 may be stored locally, while other types of diagnostic tests may be stored at a remote server.

The module hierarchy 222 may define the physical and communications links in various manners, such as based on a physical description of the interconnection (e.g. a data bus, solder trace, cable, wire, etc.). The module hierarchy 222 may also define the electrical characteristics of the interconnection/link, such as based on a technical specification corresponding to the interconnection/link (e.g. a data capacity of a bus, voltage and amperage limits, signal-to-noise limits, etc.).

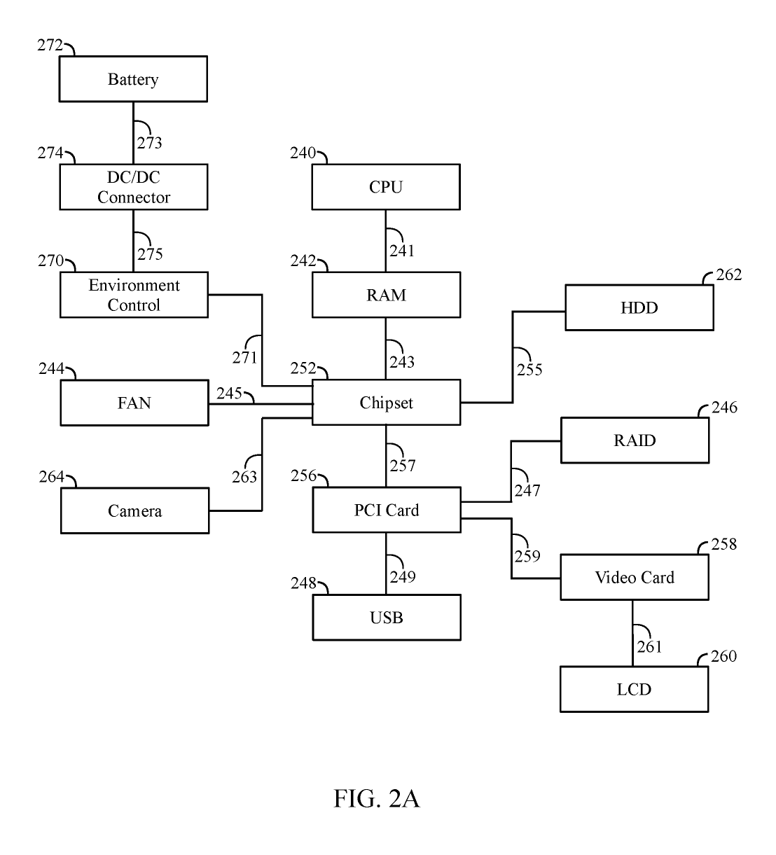

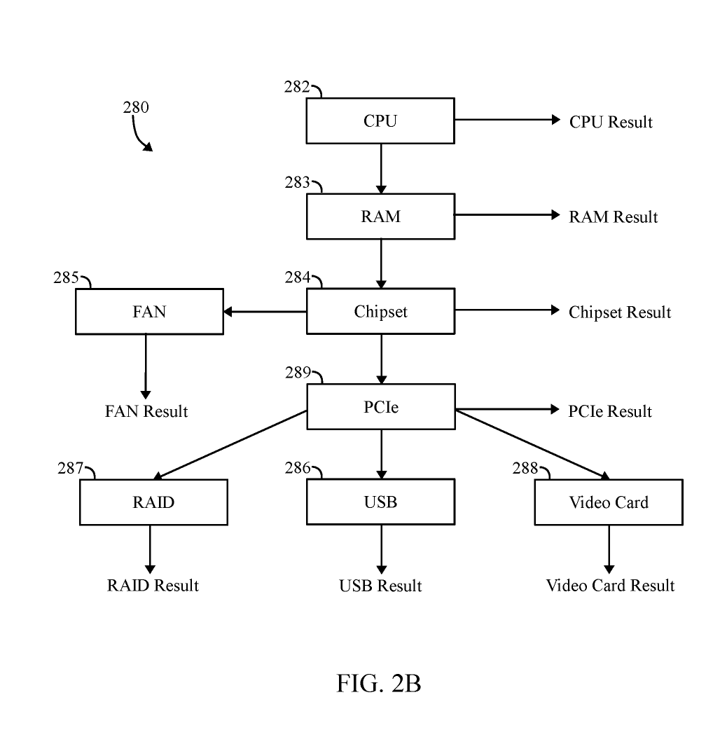

FIG. 2A is a block diagram illustrating an example of a module hierarchy 222 that may be determined and stored in accordance with an embodiment herein. The module hierarchy 222 defines an arrangement or classification of the hardware modules based on various communications interconnection criteria (e.g. power interconnections, command interconnections, data flow interconnections). The module hierarchy 222 designates a hardware module that is configured to manage diagnostic testing as the test management or base hardware module. In the example of FIG. 2A, the base hardware module represents a CPU 240 that is configured to manage the diagnostic test to be performed in connection with the various hardware modules when testing for potential failures.

Additionally or alternatively, another module, such as a chip set 252, may be designated as the test management module with respect to all or a portion of desired types of diagnostic tests. The hardware module for the CPU 240 is connected to various other hardware modules. In the example of FIG. 2A, the CPU 240 is interconnected over the communications link 241 with the RAM memory 242. The RAM memory 242 is interconnected over a communications link 243 with a chip set 252. The chip set 252 may be interconnected with the various other hardware modules. The chip set 252 is connected with the hard disk drive 262 over a communications link 255.

The chip set 252 is connected to the PCI express card 256 over a communications link 257. The PCI express card 256 is connected to the video card 258 over a communications link 259, while the video card 258 is connected to the display 260 over a communications link 261. The PCI express card 256 is also connected to a USB port 248 over a medications link 249. The PCI express card 256 is also connected to a RAID drive 246 over a communications link 247.

The chip set 252 includes various drivers/controllers that manage operation of the hardware modules connected thereto. In the present example, the chip set 252 includes a memory controller to manage operation of the RAM memory 242, and a PCI express vcontroller to manage operation of the PCI express card 256. The HDD 262 is connected to an SATA controller within the chip set 252.

As a further example, the chip set 252 may be connected over corresponding communications links 263 and 245 with a camera module 264 and a fan 244. The chip set 252 includes a fan controller. The camera unit 264 may be a USB device compatible with the USB 2.0 standard or the USB 3.0 standard. The camera unit 264 may be of an incorporation type in which it is incorporated into the housing of the device or may be of an external type in which it is connected to a USB connector attached to the housing of the device.

The hierarchy 222 also indicates an environment control (EC) circuit 270 that may include a microcontroller that controls the temperature of the inside of the housing of the device. The EC circuit 270 communicates with the chip set 252 over a communications link 271. The EC circuit 270 may operate independently of the CPU 240. The EC circuit 270 is connected to an DC-DC converter 274 over a power supply link 275, and the DC-DC converter 274 is connected to a battery 272 over a power supply link 273. The EC circuit 270 may be further connected to a keyboard, a mouse, a battery charger, an exhaust fan, and the like. The battery 272 supplies the DC-DC converter 274 with power when an AC/DC adapter (not shown) is not connected to the battery 272.

It is recognized that the module hierarchy 222 represents merely one example of a hierarchy and various alternatives may exist. The various modules illustrated in FIG. 2A may be connected to one another in alternative manners and may be connected through different types and combinations of control command, data and/or power links.

As explained herein, when it becomes desirable to test one or more hardware modules for a potential failure, multiple diagnostic tests are collected to be utilized for verifying the operation of the candidate hardware module. With reference to FIG. 2A, when the video card 258 is designated as the candidate hardware module to be verified, the CPU 240 collects diagnostic tests associated with the candidate hardware module (video card 258) as well as any hardware modules arranged upstream of the video card 258 between the video card 258 and the CPU 240. Based on the module hierarchy 222 of FIG. 2A, the intermediate HW modules represent the PCI express card 256, chip set 252 and memory 242. Accordingly, diagnostic tests are collected that are associated with the CPU 240, chipset 252, memory 242 and PCI express card 256 (as well as the diagnostic test associated with the video card 258).

FIG. 2B illustrates a block diagram of a diagnostic test hierarchy that may be utilized to interrelate diagnostic tests 280 in accordance with embodiments herein. The separate blocks in FIG. 2B correspond to separate diagnostic tests associated with the particular hardware modules. For example, one or more CPU diagnostic tests 282 are stored in memory in connection with testing various features and functionality of the CPU hardware module. In addition, one or more RAM diagnostic tests 283 are stored in connection with testing the operation of the RAM hardware module. The collection of diagnostic tests 280 also includes one or more chipset diagnostic test 284, fan diagnostic test 285, PCI express diagnostic tests 289, USB diagnostic test 286, RAID diagnostic test 287, and a video card diagnostic test 288.

The hierarchy in FIG. 2B also determines an order in which the various diagnostic tests 282-288 are performed. The test order may vary depending upon which module represents the test management module, which module represents the potentially faulty candidate HW module, and which intermediate HW modules are position there between. For example, when the CPU module represents the test management module, a CPU diagnostic test 282 may be performed first. The CPU diagnostic test 282 returns a CPU test result that is compared to a predetermined CPU valid result. When the CPU test result matches the CPU valid result, operation continues to the next diagnostic test, which represents the RAM diagnostic test 283. The RAM diagnostic test 283 is performed next to obtain one or more RAM test results. The RAM test result is compared to a predetermined RAM a valid result. When the RAM test result matches the RAM valid result, operation continues to the chipset diagnostic test 284. When the chip set test result matches the chipset valid result, operation continues. In the example of FIG. 2B, the chipset is directly linked with more than one other hardware module. Therefore, the diagnostic test performed next is dependent upon which hardware module potentially experienced a fault. When the potentially faulty candidate HW module is the fan, the fan diagnostic test 285 is performed next. Alternatively, when the PCI express card represents the potentially faulty candidate HW module, the PCI express diagnostic test is performed next.

Continuing with the foregoing example, when the CPU, RAM, chipset and PCI express card return test results that match the corresponding valid results, flow branches to the diagnostic test corresponding with the potentially faulty candidate HW module within the group of the RAID, USB and video card hardware modules. Accordingly, when the video card represents the potentially faulty candidate HW module, the CPU, RAM, chipset and PCI express card are first analyzed for potential faults. When no faults are identified in the upstream hardware modules, the video card diagnostic test 288 is next utilized to obtain a video card test result. When the video card is being tested, the USB and RAID are not tested. Alternatively, when the USB represents the potentially faulty candidate HW module, the RAID and video card are not tested. In the foregoing manner, diagnostic tests are applied to the hardware modules that are directly within the communications path between the CPU and the potentially faulty candidate HW module.

Non-limiting examples of diagnostic tests are provided hereafter that may be utilized in connection with various hardware modules. For example, when performing a memory module diagnostic, an example of a diagnostic test includes: Walking Ones Left, Walking Ones Right, Moving Inversions 32, Bit Low, Bit High, Block Move and the like. When performing a CPU module diagnostic, an example of a diagnostic test includes: Bt Instruction, MMX Test, 3D Now! test, Register tests and the like. When performing a fan module diagnostic, examples of diagnostic tests include: a Control Test. When performing a PCI express card module diagnostic, examples of diagnostic tests include: a status test. When performing a storage test, examples of diagnostic tests include: a SMART Status, Target Read, Random Seek, and Funnel Seek. When performing a video card diagnostic, examples of diagnostic tests include: Text Mode and Graphic Mode. When performing a RAID diagnostic, examples of diagnostic tests include: Controller Slot Test, Controller Link Test, and Controller Status Test. The foregoing represent non-limiting examples of some tests that may be applied.

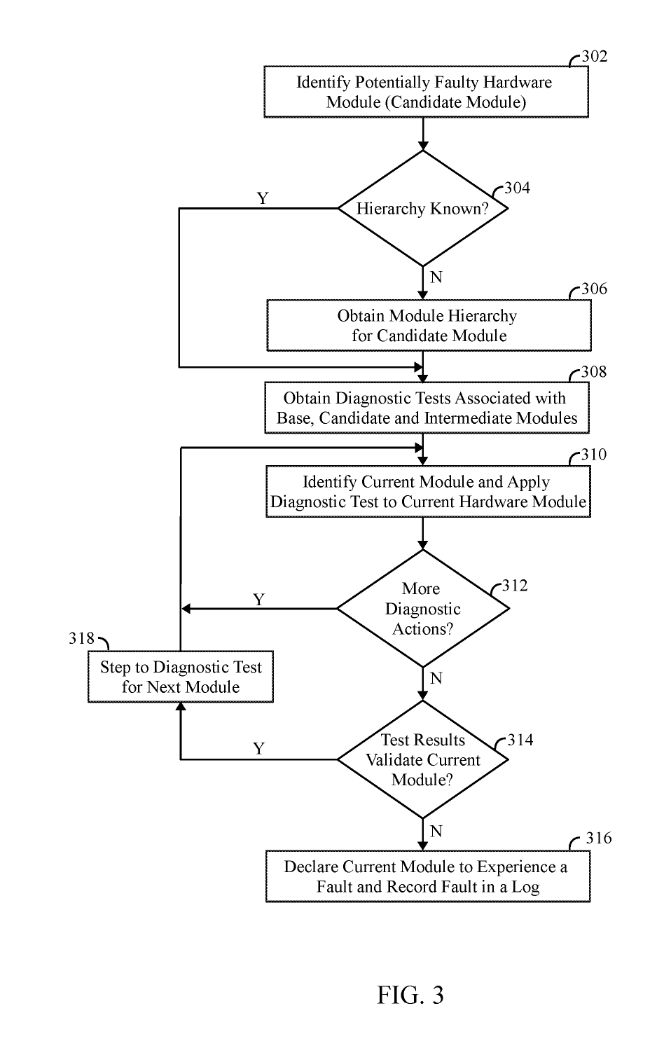

FIG. 3 illustrates a process for implementing a hierarchy-based module diagnostic in accordance with an embodiment herein. At 302, one or more processors of the device identifies a potentially faulty hardware (PFH) module to be tested (also referred to as a candidate HW module). The candidate HW module may be identified automatically during operation of the device. For example, during operation, the CPU may detect a potential fault in a video card, USB port, memory component or otherwise. Additionally or alternatively, a diagnostic operation may be initiated based on a predetermined periodic test schedule, such as during startup or shut down, based on a periodic maintenance schedule and the like. Additionally or alternatively, a diagnostic operation may be initiated based on a user request.

At 304, the one or more processors of the device determine whether a module hierarchy is known for the candidate HW modules within the device. For example, the processors may access memory 206 (FIG. 1) determine whether a module hierarchy 222 has been stored in the memory 206 in connection with the candidate HW module. When a module hierarchy 222 exist for the present candidate HW module, flow advances to 308. Otherwise, flow continues to 306.

At 306, the one or more processors of the device obtain a module hierarchy for the candidate HW module. For example, the processors may perform an automated link analysis to identify any intermediate HW modules located between the candidate HW module and the test management module. Additionally or alternatively, the processors may convey a request to a remote device or system to request a module hierarchy. For example, a device may be preloaded with a module hierarchy based on the basic manufactured configuration of the device. However, over time the device may be modified, such as adding additional accessories and replacing individual modules ((e.g. upgrading a video card, adding a RAID, interconnecting additional peripheral devices through multiple USB ports). When the original module hardware configuration is modified or updated, a corresponding module hierarchy may not be updated at the same time. Accordingly, at 304 and 306, the process of FIG. 3, enables the device to determine whether an existing module hierarchy is still accurate. When an existing module hierarchy is no longer accurate or does not include information for a particular accessory representing a candidate HW module, the processors may request a current module hierarchy from a remote source and/or determine the module hierarchy automatically.

At 308, the one or more processors of the device obtains a collection of diagnostic tests associated with the base, candidate and intermediate HW modules. The collection of diagnostic tests may be obtained in various manners. For example, in accordance with one embodiment, to obtain the collection of diagnostic tests, the module hierarchy 222 is referenced to identify the candidate HW module, the base module and any intermediate HW modules located along a communications path there between. As noted in connection with FIG. 2A, the module hierarchy 222 defines the physical and electrical interconnections between the candidate HW module and the base module, including all intermediate HW modules. Examples are described herein for various combinations of base, test and intermediate HW modules. Each combination of base, test and intermediate HW modules includes one or more related sets of diagnostic tests.

The diagnostic tests may be uploaded at the time of manufacture, distribution or sale of the device. Additionally or alternatively, the diagnostic tests may be uploaded after a user begins utilizing the device. For example, the diagnostic tests may be downloaded to the device in connection with an upgrade, update or otherwise. Throughout operation, the diagnostic tests may be revised and supplemented. As one example, as additional diagnostic tests are developed in connection with particular types of faults, the new diagnostic test may be uploaded to replace an existing diagnostic test or be used in addition to an existing diagnostic test. As a further example, when a new hardware module (e.g. video card, the driver, etc.) is added to a device, one or more related diagnostic tests may be uploaded to the collection of diagnostic tests.

At 310, the one or more processors of the device identify a current module to be tested. The order in which the hardware modules are tested corresponds to a downstream communications path from the test management module to the candidate HW module. As explained herein, the diagnostic tests are organized such that hardware modules closest to the test management (base) module are first tested. At 310, the one or more processors sends one or more diagnostic actions to the hardware module being tested. The processors wait for a corresponding number of diagnostic results to be returned from the hardware module and records the test result.

At 312, the one or more processors determine whether additional diagnostic actions should be performed by the hardware module. For example, the diagnostic test to be applied to the hardware module may include a series of diagnostic actions that are to be performed in a managed manner. For example, during a first iteration through 310 and 312, a first action may occur and a first test result stored. The decision at 312 may simply be to step through a series of test actions and record corresponding test results. Additionally or alternatively, the decision at 312 may be based on the prior test results. For example, depending upon a particular test result, the processors may determine that additional and/or alternative additional diagnostic actions are to be performed.

Additionally or alternatively, the determination at 312 may be removed entirely and all diagnostic actions associated with the current hardware module may be performed at once, and all corresponding tests results received at 310. Once the operations at 310 and 312 are completed, flow moves to 314.

At 314, the one or more processors of the device determine whether the test results received at 308 are valid for the corresponding module. For example, the test results may be compared with one or more predetermined valid results. When returned test results match predetermined valid results, the current module is determined to be validated and accordingly, flow continues from 314 to 318. Otherwise flow moves to 316.

At 318, the one or more processors of the device step through the collection of diagnostic tests to one or more diagnostic test associated with the next hardware module to be tested. For example, the collection of diagnostic tests may be organized in various manners. As one example, a file may be maintained with each diagnostic test organized in an order of operations. During each iteration through the operation at 314, the one or more processors steps to the next link in the order of operations. From 318, flow returns to 310.

Returning to 314, when the returned test results do not match a predetermined valid result, flow branches to 316. At 316, the one or more processors of the device declare the current module being tested to be experiencing a fault. At 316, a notification may be conveyed to a user, to a remote server or elsewhere. Further, the diagnostic test may be terminated at 316. At 316, the nature of the fault is also recorded in a log for future analysis and troubleshooting. When an intermediate HW module is determined to experience a fault, the operations of FIG. 3 may terminate without testing the potentially faulty candidate HW module.

Optionally, the operations of FIG. 3 may continue to test each intermediate HW module and the candidate HW module, even when a potential fault is identified within an intermediate HW module. The faults within one or more intermediate HW modules and/or the candidate HW module may be recorded in a log.

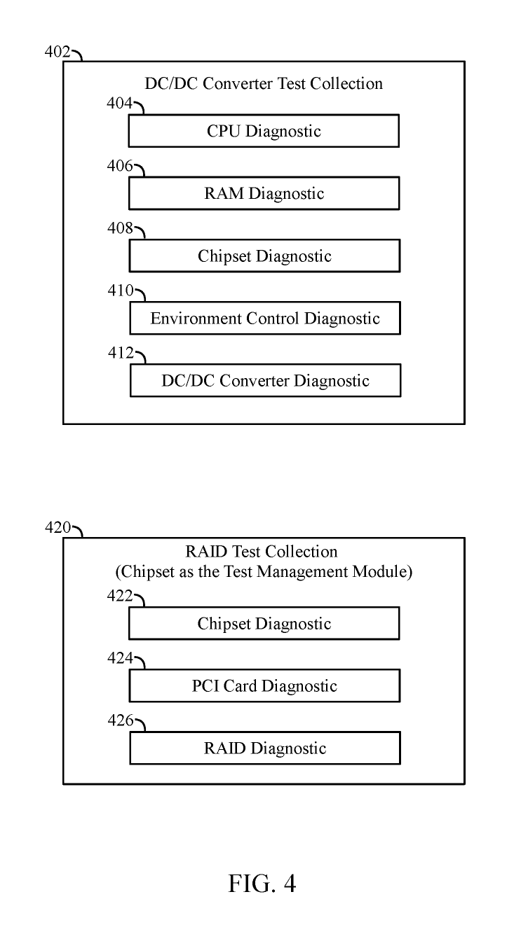

FIG. 4 illustrates collections of diagnostic tests that may be utilized in connection with embodiments herein. A DC/DC converter test collection 402 includes a collection of diagnostic tests based upon a module hierarchy in which a CPU represents a test management module, with intervening RAM, chipset and environment control modules located between the CPU and the DC/DC converter module. The DC/DC converter test collection 402 includes a CPU diagnostic test 404, RAM diagnostic test 406, a chipset diagnostic test 408, and environment control diagnostic test 410 and a DC/DC converter diagnostic test 412. The diagnostic test within the test collection 402 are arranged in an order of operation assuming that the RAM module is positioned upstream closest to the CPU, with the environment control module located downstream adjacent the DC/DC converter and the chipset arranged there between.

FIG. 4 also illustrates a RAID test collection 420 that includes a collection of diagnostic test based on a module hierarchy in which the chipset represents the test management module, while the RAID module represents the candidate HW module. The RAID test collection 420 orders the diagnostic test with the chipset diagnostic test 422 to be performed first, followed by a PCI card diagnostic test 424 which is followed by a RAID diagnostic test 426.

Optionally, embodiments herein may be utilized to perform diagnostics in connection with failures that may be at least partially based on software. For example, a failure may be indicated when the Windows software package is not properly loaded. When a potential failure is identified in connection with software, such as the Windows software package, embodiments herein may perform hardware-based diagnostics related to the hardware that implements the software. For example, when the Windows software package is not properly loaded, a collection of diagnostic test may include a test to check whether any appropriate drivers are correctly loaded, whether the operating system kernel is operating properly, whether firmware has been uploaded properly and the like. Accordingly, the nature of the failure may not be limited to a hardware failure, but instead may include software failures. The corresponding diagnostic test will include testing hardware modules implementing the software potentially experiencing the failure.

As another example, when opening a browser, a webpage may not properly load. When a failure relates to a webpage loading error, various hardware module diagnostic test may be performed, in addition to software diagnostic test. For example, in response to detecting a webpage loading error, the diagnostic test may analyze the PCI express card, the ether ports, a wireless antenna, as well as any hardware modules that implements software and firmware in connection with opening the web browser and loading the webpage.

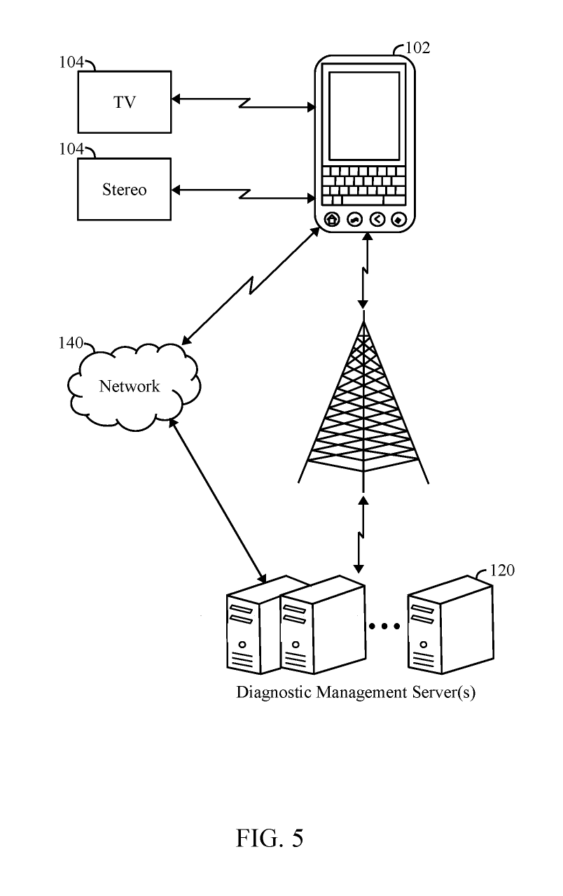

FIG. 5 is a block diagram of a system for hierarchy based hardware module diagnostics in accordance with embodiments herein. The system includes a base device 102, one or more secondary devices 104, one or more diagnostic management servers 120. The foregoing examples are provided in connection with a device performing a self-diagnostic upon the hardware modules within the device. Optionally, the operations described herein may be performed by a base device 102 as a remote diagnostic upon the hardware modules within a separate secondary device 104. For example, a smart phone or other electronic device 102 may be utilized to perform diagnostics upon another electronic device 104, such as a television, stereo, Internet router and the like. Optionally, the diagnostic test described herein may be performed by a server 120 or other network computer. For example, a base device 102 may establish a network connection with a diagnostic management server 120 which performs the various diagnostic test described herein. Additionally or alternatively, the diagnostic management server 120 may direct the device to perform certain diagnostic test in an order as described herein and return the test results to the test management server.

By way of example, the base device 102 may be a mobile device, such as a cellular telephone, smartphone, tablet computer, personal digital assistant, laptop/desktop computer, gaming system, a media streaming hub device or other electronic terminal that includes a user interface and is configured to access a network 140 over a wired or wireless connection. As non-limiting examples, the base device 102 may access the network 140 through a wireless communications channel and/or through a network connection (e.g. the Internet). Optionally, the base device 102 may be responsive to voice commands. Additionally or alternatively, the base device 102 may be a wired or wireless communication terminal, such as a desktop computer, laptop computer, network-ready television, set-top box, and the like. The base device 102 may be configured to access the network using a web browser or a native application executing thereon. In some embodiments, the base device 102 may have a physical size or form factor that enables it to be easily carried or transported by a user, or the base device 102 may have a larger physical size or form factor than a mobile device.

The secondary device 104 may represent the same or different type of device as the base device 102, such as a tablet computer, mobile phone, personal digital assistant, laptop/desktop computer and the like. In addition, other non-limiting examples of secondary devices 104 include televisions, stereos, home appliances, network devices (e.g. routers, hubs, etc.), remote-controlled electronic devices, a wearable device such as a smart watch or smart glasses, home automation electronic hubs (e.g. the Amazon Echo device), content management and streaming devices (e.g. the Chrome Cast device, Roku device, Kire TV stick device, Sonos devices), video games, cameras, camcorders, drones, toys, home theater systems, automobiles, GPS systems, audio content players and the like.

The base device 102 is configured to communication over the network 140 with the diagnostic management servers 120. The diagnostic management servers 120 may be maintained by manufacturers, distributors, wholesale or retail sellers, as well as other entities in connection with supporting or otherwise offering the base device 102 and/or the secondary devices 104. Additionally or alternatively, the diagnostic management servers 120 may be managed and operated by a third-party service.

The base device 102 is configured to access diagnostic management servers 120, including web-based or network-based data, applications, and services, via the network 140. The network 140 may represent one or more of a local area network (LAN), a wide area network (WAN), an Intranet or other private network that may not be accessible by the general public, or a global network, such as the Internet or other publicly accessible network. The network 140 provides communication between the base device 102 and one or more diagnostic management servers 120. It will be understood that, in some embodiments, the diagnostic management servers 120 may represent a single entity or one or more physical or virtual servers that are configured to deliver module hierarchies and/or diagnostic tests to the base device 102. The diagnostic management servers 120 may represent a Web service or a network service for an e-commerce business, financial institution, or any other commercial, noncommercial, personal, nonprofit or other entity.

The base device 102 may perform hierarchy-based diagnostic test as described herein with the support of the diagnostic management servers 120. The base device 102 may perform the diagnostic test upon the hardware modules within the base device 102. Additionally or alternatively, the base device 102 may perform the diagnostic test upon a secondary device 104. The base device 102 may utilize module hierarchies 222 (FIG. 1) and/or diagnostic test 226 stored within memory in the base device 102. Additionally or alternatively, the base device 102 may utilize module hierarchies 222 and diagnostic test 226 that are stored on the diagnostic management servers 120 and/or on the secondary devices 104.

As will be appreciated by one skilled in the art, various aspects may be embodied as a system, method or computer (device) program product. Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The units/modules/applications herein may execute a collection of instructions that are stored in one or more storage elements, in order to process data. The storage elements may also store data or other information as desired or needed. The storage element may be in the form of an information source or a physical memory element within the modules/controllers herein. The collection of instructions may include various commands that instruct the units/modules/applications herein to perform specific operations such as the methods and processes of the various embodiments of the subject matter described herein. The collection of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method, comprising:
under control of one or more processors configured with specific executable program instructions,
identifying a candidate hardware (HW) module to be tested for a potential failure, the candidate HW module connected through an intermediate HW module with a test management module, the test management module to manage diagnostic testing for the potential failure;
obtaining first and second diagnostic tests, the first diagnostic test associated with the intermediate HW module and the second diagnostic test associated with the candidate HW module;
applying the first diagnostic test to the intermediate HW module to verify operation of the intermediate HW module; and
applying the second diagnostic test to the candidate HW module based on verified operation of the intermediate HW module.

2. The method of claim 1, further comprising obtaining a module hierarchy designating the intermediate HW module based on a communications link through the intermediate HW module between the test management module and candidate HW module, and identifying the first diagnostic test associated with the intermediate HW module.

3. The method of claim 1, further comprising declaring the intermediate HW module to exhibit a failure when the first diagnostic test indicates a fault.

4. The method of claim 3, further comprising suspending application of the second diagnostic test when the intermediate HW module is declared to exhibit a fault.

5. The method of claim 1, wherein the intermediate HW module includes upstream and downstream intermediate HW modules arranged along a communications link between the test management module and the candidate HW module, the method further comprising:
applying corresponding diagnostic tests to the upstream and downstream intermediate HW modules to verify operation thereof, and
applying the second diagnostic test to the candidate HW module based on verified operation of the upstream and downstream intermediate HW modules.

6. The method of claim 1, determining whether a module hierarchy is known in connection with the candidate HW module, and obtaining a module hierarchy based on the determining.

7. The method of claim 1, wherein applying the first diagnostic test includes conveying diagnostic actions to be performed by the intermediate HW module and receiving test results corresponding to the diagnostic actions.

8. The method of claim 1, further comprising receiving test results from the intermediate HW module based on the first diagnostic test, comparing the test results with valid results and verifying the intermediate HW module based on the comparison.

9. A device, comprising:
a processor;
a memory storing program instructions accessible by the processor;
wherein, responsive to execution of the program instructions, the processor performs the following:
identify a candidate hardware (HW) module to be tested for a potential failure, the candidate HW module connected through an intermediate HW module with a test management module, the test management module to manage diagnostic testing for the potential failure;
obtain first and second diagnostic tests, the first diagnostic test associated with the intermediate HW module and the second diagnostic test associated with the candidate HW module;
apply the first diagnostic test to the intermediate HW module to verify operation of the intermediate HW module; and
apply the second diagnostic test to the candidate HW module based on verified operation of the intermediate HW module.

10. The device of claim 9, wherein the processor obtains a module hierarchy designating the intermediate HW module based on a communications link through the intermediate HW module between the test management module and candidate HW module, and identifying the first diagnostic test associated with the intermediate HW module.

11. The device of claim 9, wherein the processor declares the intermediate HW module to exhibit a failure when the first diagnostic test indicates a fault.

12. The device of claim 11, wherein the processor suspends application of the second diagnostic test when the intermediate HW module is declared to exhibit a fault.

13. The device of claim 9, wherein the intermediate HW module includes upstream and downstream intermediate HW modules arranged along a communications link between the test management module and the candidate HW module, and wherein the processor:
applies corresponding diagnostic tests to the upstream and downstream intermediate HW modules to verify operation thereof, and
applies the second diagnostic test to the candidate HW module based on verified operation of the upstream and downstream intermediate HW modules.

14. The device of claim 9, wherein the processor obtains determines whether a module hierarchy is known in connection with the candidate HW module, and obtains a module hierarchy based on the determination.

15. The device of claim 9, wherein the processor applies the first diagnostic test by conveying diagnostic actions to be performed by the intermediate HW module and receiving test results corresponding to the diagnostic actions.

16. The device of claim 9, wherein the processor receives test results from the intermediate HW module based on the first diagnostic test, compare the test results with valid results and verifies the intermediate HW module based on the comparison.

17. A computer program product comprising a non-signal computer readable storage medium comprising computer executable code to:
identify a candidate hardware (HW) module to be tested for a potential failure, the candidate HW module connected through an intermediate HW module with a test management module, the test management module to manage diagnostic testing for the potential failure;
obtain first and second diagnostic tests, the first diagnostic test associated with the intermediate HW module and the second diagnostic test associated with the candidate HW module;
apply the first diagnostic test to the intermediate HW module to verify operation of the intermediate HW module; and
apply the second diagnostic test to the candidate HW module based on verified operation of the intermediate HW module.

18. The computer program product of claim 17, wherein the computer executable code further comprising obtaining a module hierarchy designating the intermediate HW module based on a communications link through the intermediate HW module between the test management module and candidate HW module, and identifying the first diagnostic test associated with the intermediate HW module.

19. The computer program product of claim 17, wherein the computer executable code further comprising declaring the intermediate HW module to exhibit a failure when the first diagnostic test indicates a fault.

20. The computer program product of claim 17, wherein the computer executable code further comprising suspending application of the second diagnostic test when the intermediate HW module is declared to exhibit a fault.
